(19) United States
(12) Patent Application Publication
(10) Pub. No.: US 2015/0232347 A1
(43) Pub. Date: Aug. 20, 2015

(54) Water Reclaim System

(71) Applicant: Edward A. Bray, San Juan, PR (US)

(72) Inventor: Edward A. Bray, San Juan, PR (US)

(21) Appl. No.: 14/627,070

(22) Filed: Feb. 20, 2015

Related U.S. Application Data
(60) Provisional application No. 61/942,050, filed on Feb. 20, 2014.

(51) Int. Cl. C02F 1/02; C02F 1/44

(52) U.S. Cl. CPC C02F 1/02; C02F 1/444

(57) ABSTRACT

An apparatus and method to water collection, treatment, and/or reutilization. A water recovery system comprising at least a filtration equipment and water conditioning/precipitation equipment. The water recovery system may further include an automation, monitor, and control system for automating, monitoring, and/or controlling, for example, the flow of wastewater, minerals at the water, the end use of the wastewater, etc.

### RELATED APPLICATIONS

The present application claim the benefit of priority of U.S. provisional application 61/942,050, filed on Feb. 20, 2014

### STATEMENT REGARDING FEDERALLY SPONSORED RESEARCH AND DEVELOPMENT

N/A

### BACKGROUND OF THE INVENTION

1. Field of the Invention

The present disclosure relates to a water reclaim system and method for the treatment of wastewater from cooling equipment or boiler, such as a cooling tower, more particularly to an apparatus and method to separate contaminants from wastewater before reaching the sewers or to provide water which may be reused as water for the cooling tower or boiler.

2. Discussion of the Background

Water, which used is used to cool many of the areas or devices within buildings and facilities has become an expensive resource. Therefore, reducing water use can lower operational costs for a building and benefit the environment.

Further, water is available from cooling towers through evaporation and drift losses. The water drained from cooling equipment is called “blow-down” water or “bleed” water. Examples of cooling equipment that requires blow-down are cooling towers and boilers. Unfortunately, the minerals content on the remaining water increases in concentration of minerals as the water evaporates. The blow-down water containing minerals will cause scaling on equipment surfaces; possibly damaging the system. Typically, the blow-down water is usually dumped into the sanitary drain or/and drained into sewer lines, but the mineral content has to be in compliance with the environmental laws.

Thus, it can be appreciated from the foregoing that a system for water collection, treatment, and/or reutilization for certain end uses is desired. Furthermore, it is desirable a refrigeration/cooling system with a residue interceptor to contain effectively the residues flowing through the wastewater/blow-down before reaching the sewers and or recirculating said water into the system in order to provide water with an acceptable salinity or mineral content.

### SUMMARY OF THE INVENTION

The present invention overcomes the disadvantages of the Prior Art providing a residue interceptor for a cooling and/or refrigeration systems, wherein said residue interceptors provide wastewater in compliance with current law requirements.

Another object of the invention is to provide a water reclaim system that is easily integrated into a current or new building water system.

Yet another object of the invention is to provide a method of reusing waste water comprising a water recuperation equipment, wherein said water recuperation equipment includes a water conditioning/precipitation equipment and an ultrafiltration equipment.

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings which are incorporated herein constitute part of the specifications and illustrate the preferred embodiment of the invention.

FIG. 1 is a diagram of the boiler water recuperation first embodiment in accordance with the principles of the present disclosure.

FIG. 2 is a diagram of the cooling tower water recuperation first embodiment in accordance with the principles of the present disclosure.

### DESCRIPTION OF THE PREFERRED EMBODIMENT

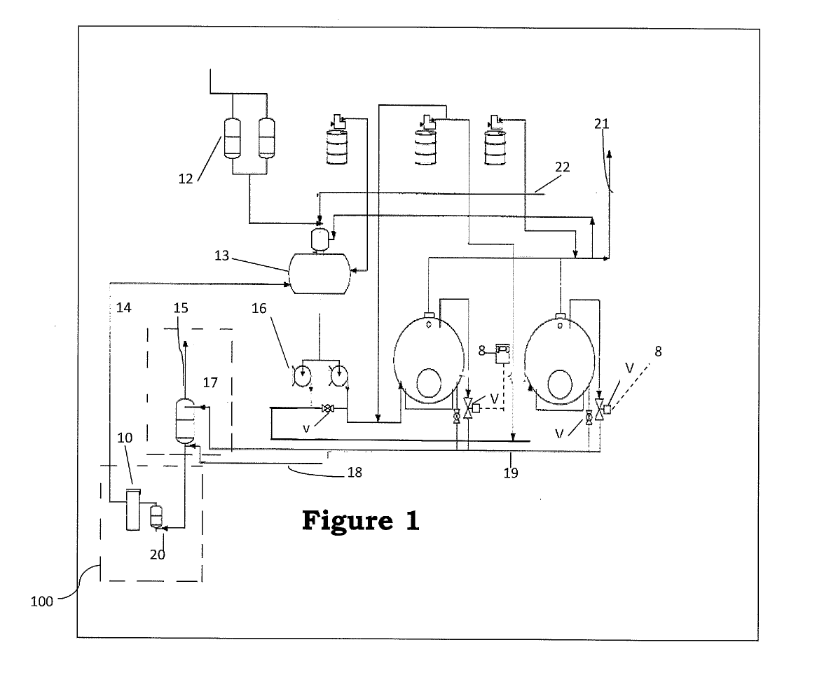

FIG. 1 is directed to the first embodiment of the present invention including a boiler system including the water recuperation equipment or water reclaims system. Mainly the boiler system 1000 provides steam of hot water to the facilities 21. Several conducts serves as a path from the boiler to the blow-down lines 19. Water at the blow-down lines 19 is directed to a heat exchanger system, wherein said heat exchanger system comprises at least a pump and a heat exchanger 17, wherein said heat changer may receive cooling water 18 and is provided with ventilation 15. After the water directed from the blow-down lines is exposed to the heat exchanger it is directed to the water recuperation equipment. The water recuperation equipment comprises at least a water recuperation equipment 100 comprising at least a water conditioning/precipitation equipment 20 coupled to water filtration equipment 10, wherein said water filtration equipment is a ultrafiltration equipment. One of the benefits of providing a ultrafiltration equipment is reusing water waste but at the same time removing unwanted residues that may damage the boiler system. Reusing waste water reduces costs and at the same time provides a better analysis on residues, more particularly on pipes use for directing said waste water to the sewers.

The waste water is treated by the water recuperation equipment an redirected and storage at a feedwater tank 13. Water is then pumped out of the feedwater tank 13 to the boilers by at least a feed pump 16. Condensate water 22 from the facilities and pre-treatment make-up 12 is directed to the feedwater tank 13. The system is controlled by a controlled system 8 comprising PLC, treatment controller, sensor and timers. The flow of water is manipulated by several valves V, wherein said valves V are controlled by controller system 8. Having water recuperation equipment 100 located after a heat exchanger 17 made the system more efficient because more particulars and residues are added to waste material due to environment exposure at this step of the process in multiple cases. Therefore locating water recuperation equipment located after a heat exchange helps to react with incoming feedwater hardness and prevent it from precipitating on the boiler metal, eliminates any suspended matter such as hardness sludge in the boiler, provide protection to boiler, eliminates oxygen from the feedwater, prevent boiler corrosion and corrosion in the steam-condensate systems.

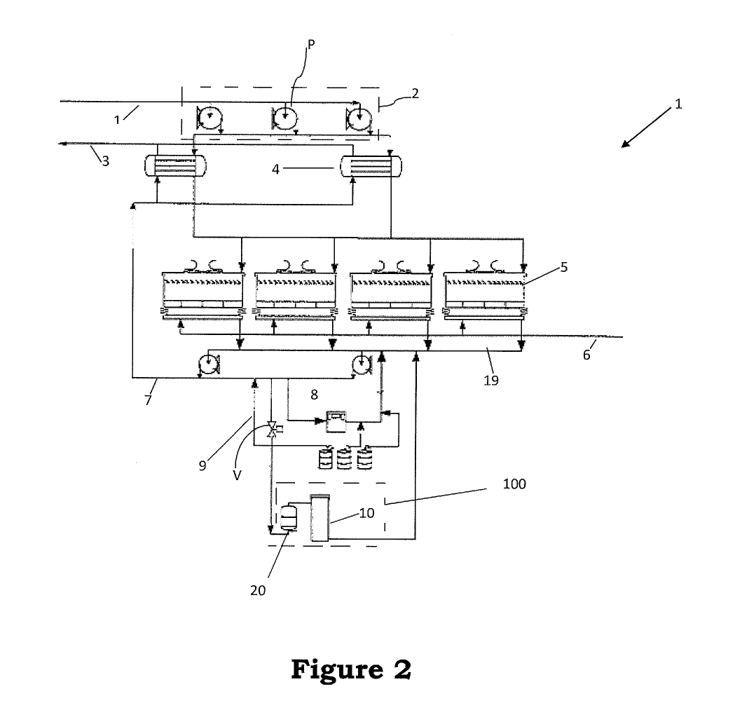

FIG. 2 is directed another system that generates water waste, more in particularly the second embodiment of the present invention includes a cooling tower system 1001 including the water recuperation equipment 100. Water is directed from the facilities 1 toward the chiller/heat exchangers 4 by means of several pumps P. After the chiller 4 the water is redirected to the Cooling towers 5. Several conducts serves as a path from the cooling tower to the blow-down lines that are directed to a water recuperation equipment. Similar to the previous embodiment, the water recuperation equipment comprises at least a water conditioning/precipitation equipment 20 coupled to a water filtration equipment 10, as mentioned above. The water is treated by the water recuperation equipment an redirected to the chillers before reaching the facilities. The system is controlled by a controlled system 8 comprising PLC, treatment controller, sensor and timers. The flow of water is manipulated by several valves V also controlled by controller system 8. The controller system 8 generates signals in order to open or close the valves depending on the reading of several sensor, wherein said reading is compared to a predetermined value. The values V, program for the controlled system 8 and type of sensor may vary depending on the task.

Similar to the first embodiment the location of the water recuperation equipment 100 is important since the second embodiment system will be more efficient when the particulars and residues are added to waste material due to environment exposure are eliminated on the presented process in multiple cases.

While the invention has been described as having a preferred design, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A water recovery system comprising:
waste water;
a water state changing system;
a plurality of pipes and at least a first valve;
at least a heat exchanger system;
a controlled system; and
a water recuperation equipment comprising a water conditioning/precipitation equipment coupled to water filtration equipment; wherein said water state changing system comprises a blowdown line; and wherein the blowdown line directs the waste water to said water recuperation equipment after exposed to said heat exchanger system.

2. The water recovery system as in claim 1,
wherein the water state changing system is a boiler system comprising at least a boiler.

3. The water recovery system as in claim 2,
wherein said blowdown line directs the waste water from the boiler to said heat exchanger system; and said heat exchanger system directs the waste water to said water recuperation equipment after exposed to said heat exchanger system.

4. The water recovery system as in claim 1,
wherein the water state changing system is a cooling tower system comprising cooling towers.

5. The water recovery system as in claim 4,
wherein said blowdown line directs the waste water from the cooling towers toward to said water recuperation equipment after exposed to said heat exchanger system.

6. The water recovery system as in claim 1,
wherein the filtration equipment is an ultrafiltration system.

7. The water recovery system as in claim 1;
Wherein said controlled system controls the flow of water waste to said water recuperation equipment.
